(19) United States
(12) Patent Application Publication
(10) Pub. No.: US 2020/0255136 A1
(43) Pub. Date: Aug. 13, 2020

(54) Vertical Flight Aircraft With Improved Stability

(71) Applicant: Karem Aircraft, Inc., Lake Forest, CA (US)

(72) Inventor: Abe Karem, N. Tustin, CA (US)

(21) Appl. No.: 16/677,453

(22) Filed: Nov. 7, 2019

Related U.S. Application Data
(60) Provisional application No. 62/757,869, filed on Nov. 9, 2018.

(51) Int. Cl. B64C 29/00; B64D 7/00; B64D 1/06; B64D 1/10; B64C 39/02; B64D 25/12

(52) U.S. Cl. CPC B64C 29/0033; B64D 7/00; B64D 1/06; B64D 2033/045; B64C 39/024; B64D 25/12; B64D 1/10

(57) ABSTRACT

Devices and systems of the inventive concept provide a durable, all-weather manned or unmanned aircraft that is capable of vertical flight and provides improved stability upon payload launch or delivery. The payload bay is positioned along the central axis of the aircraft and proximal to the aircraft's center of gravity. Control and fuel systems are positioned fore and aft of the payload bay, respectively. The payload bay is configured to store and deliver a wide variety of payload types. The aircraft also includes features that reduce vibration, prolong the interval between necessary maintenance, and permit all-weather operation.

This application claims the benefit of U.S. Provisional Patent Application No. 62/757,869 filed on Nov. 9, 2018. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is aircraft capable of vertical flight.

### BACKGROUND

The following description includes information that may be useful in understanding the present invention. It is not an admission that any of the information provided herein is prior art or relevant to the presently claimed invention, or that any publication specifically or implicitly referenced is prior art.

Aircraft utilized for payload delivery are subject to loss of stability on payload deployment, particularly when relatively small aircraft (for which payload may represent a significant portion of the mass of the loaded aircraft) are utilized for this purpose.

Various tilt rotor aircraft, both manned and unmanned, are currently used for payload delivery. These include the Bell V-280 Valor, the Bell V-247 Vigilant, the Augusta Westland AW-609, and the V-22 Osprey. These aircraft are designed for military use, a role that encompasses in-flight delivery of weapons payloads. Mass is typically minimized in such aircraft in order to reduce costs and improve performance, however in-flight payload delivery necessarily results in sudden changes in the total weight and weight distribution of such aircraft while airborne. Unfortunately such minimization of aircraft weight can contribute to instability. While the above aircraft have achieved a degree of success in certain operations, all of them can suffer from loss of stability upon payload delivery.

Thus, there is still a need for tilt rotor aircraft designs with enhanced stability.

### SUMMARY OF THE INVENTION

Systems and devices of the inventive concept provide a vertical takeoff and landing (VTOL) and/or tilt rotor aircraft with features that provide improved stability during in flight payload delivery relative to conventional VTOL and/or tilt rotor aircraft.

One embodiment of the inventive concept is a manned or unmanned vertical flight capable aircraft (e.g. a rotorcraft, winged aircraft, tilt rotor aircraft, tilt wing aircraft, etc.) that includes a fuselage having a fuselage length and a payload bay positioned within about 10% of the fuselage length of the vertical flight capable aircraft's center of gravity, and optionally a quad landing gear that is retractable into the fuselage. The payload bay is positioned such that deployment of a payload from the payload bay results in a shift in position of the vertical flight capable aircraft's center of gravity of less than about 4% of the fuselage length. The payload bay is configured to store a plurality of weapon types, and can include bay doors positioned beneath the aircraft as well as a gravity drop mechanism for releasing payload through the bay doors. The vertical flight capable aircraft can include weapons launchers, such as a weapon launcher coupled to a side of the fuselage and/or a weapon launcher configured to launch a weapon from a door of the vertical flight capable aircraft. Other features include an avionics assembly (which can be modular and/or removable) positioned forward of the payload bay and an infrared suppressor (such as an upward directed exhaust) positioned aft of the payload bay.

The aircraft includes one or more engines and/or electric motors. Single engine implementations can include a single engine coupled to the fuselage and with an output of up to1300 horsepower. Multi-engine implementations of the aircraft can include two or more engines coupled to a wing of the vertical flight capable aircraft, where each of the engines has an output of 700 to 1300 horsepower. Aircraft of the inventive concept can include an Optimum Speed Rotor (OSR), and/or an Optimum Speed TiltRotor (OSTR) lift and propulsion mechanism. In some embodiments the aircraft includes a Karem Aircraft Butterfly wing flap.

Vertical flight capable aircraft of the inventive concept can include safety features that provide it with the ability to fly in all weather conditions. For example, such an aircraft can include an electro-thermally heated portion of aircraft skin, a lighting-strike protection feature, an engine air particle separator, an abrasion-resistant surface coating, and/or a sensor suite.

Vertical flight capable aircraft can include features that reduce the need for regular maintenance and/or provide extended (e.g. one month or more) periods of maintenance-free operation. Such features include an all-electric architecture, a higher-harmonic blade pitch control system, a vibration mitigation system, a rigid rotor system, use of two or more modular mission systems, a low-maintenance engine air particle separator, and/or incorporation of an abrasion-resistant surface coating.

The payload bay of a vertical flight capable aircraft of the inventive concept can include payload bay doors that are positioned beneath the aircraft, along with a delivery mechanism designed to extend the payload below and exterior to the aircraft for fore or aft delivery. The aircraft can also include one or more bay door(s) positioned to provide access to the payload bay. A removable reinforcing structure can be attached to at least a portion of the payload bay door. In some embodiments the vertical flight capable aircraft includes a payload release system, which can be gravity-driven.

In some embodiments a vertical flight capable aircraft of the inventive concept includes a missile launch system, which can be at least partially positioned within the payload bay. Examples of suitable missile launch systems include a JAGM rail system, a LAU-61 system, and/or a LAU-131 system. Similarly, in some embodiments a vertical flight capable aircraft of the inventive concept can include an unmanned aerial vehicle (UAV) release system, at least a portion of which can be positioned within the payload bay. In some embodiments such an UAV release system includes a common launch tube utilized by different UAVs.

### BRIEF DESCRIPTION OF THE DRAWINGS

FIGS. 1A-1D: FIGS. 1A to 1D depict embodiments of a manned tiltrotor aircraft of the inventive concept. FIG. 1A shows a side view of such an aircraft (top), a typical wing profile (middle), and a typical propeller (bottom). FIG. 1B shows an oblique view of such an aircraft, with the starboard rotor positioned for vertical flight/hover and the port rotor positioned for cruise. FIG. 1C shows a top-down view of such an aircraft with the rotors positioned for cruise. FIG. 1D shows a front view of such an aircraft with the rotors positioned for cruise.

FIGS. 2A-2E: FIGS. 2A to 2E depict exemplary embodiments of unmanned aircraft of the inventive concept. FIG. 2A provides top-down (top left), oblique (top right), front (bottom left), and side (bottom right) views of such an aircraft. FIG. 2B provides a space-filling oblique view of such an aircraft with rotors positioned for cruise. FIG. 2C provides a space-filling oblique view of such an aircraft with rotors positioned for vertical flight/hover. FIG. 2D provides a space-filling oblique view of an alternative embodiment of such an aircraft with rotors positioned for cruise. FIG. 2E provides a space-filling oblique view an alternative embodiment of such an aircraft with rotors positioned for vertical flight/hover.

FIG. 3: FIG. 3 depicts a space-filling view of an aircraft of the inventive concept configured for stowing by rotation of wing and tail structures.

FIG. 4: FIG. 4 depicts a cross section of an aircraft of the inventive concept.

FIG. 5: FIG. 5 depicts an aircraft of the inventive concept with the doors of the payload section open.

FIG. 6: FIG. 6 depicts an example of an ejection rack configured to function within a payload bay of an aircraft of the inventive concept.

FIGS. 7A and 7B: FIGS. 7A and 7B depict examples of rail systems suitable for weapons delivery from an aircraft of the inventive concept. FIG. 7A shows an example of a two-rail system that includes a wedge adapter. FIG. 7B shows examples of two-rail and four-rail systems.

FIGS. 8A and 8B: FIGS. 8A and 8B depict examples of rocket launching systems suitable for use with aircraft of the inventive concept. FIG. 8A shows a LAU-61 rocket launcher. FIG. 8B shows a LAU-131 rocket launcher.

FIG. 9: FIG. 9 depicts an example of an unmanned aerial vehicle (UAV) suitable for launching from an aircraft of the inventive concept.

### DETAILED DESCRIPTION

The inventive subject matter provides apparatus, systems and methods in which an aircraft capable of vertical flight is provided that has enhanced stability on in-flight payload delivery and/or non-flight payload delivery in comparison to prior art designs. Suitable aircraft capable of vertical flight include rotorcraft, winged rotorcraft, tilt wing aircraft, and tilt rotor aircraft. Such aircraft can have a single, fuselage mounted engine. Alternatively, such aircraft can have two or more engines mounted on a wing of the aircraft. Such engines can have an output of from 700 to 1,300 horsepower. It should be appreciated that the systems and methods described below are applicable to both manned and unmanned aircraft, and that both are considered. Although many examples are directed towards tilt rotor aircraft, all aircraft capable of vertical flight are considered, including rotorcraft, winged craft, tilt rotor aircraft, and tilt wing aircraft.

One embodiment of the inventive concept is a manned or unmanned vertical flight capable aircraft (e.g. a rotorcraft, winged aircraft, tilt rotor aircraft, tilt wing aircraft, etc.) that includes a fuselage having a fuselage length and a payload bay positioned proximally to the aircrafts center of gravity (i.e. within a distance of about 1%, 5%, 10%, 15%, or 20% of the fuselage length of the vertical flight capable aircraft from its center of gravity). Such positioning advantageously reduces shifting of the aircraft's center of gravity upon release of payload stowed within or partially within the payload bay. In preferred embodiments the payload bay is positioned such that deployment of a payload from the payload bay results in a shift in position of the vertical flight capable aircraft's center of gravity of less than about 10%, 8%, 6%, 4%, or 2% of the fuselage length from the aircraft's center of gravity prior to deployment.

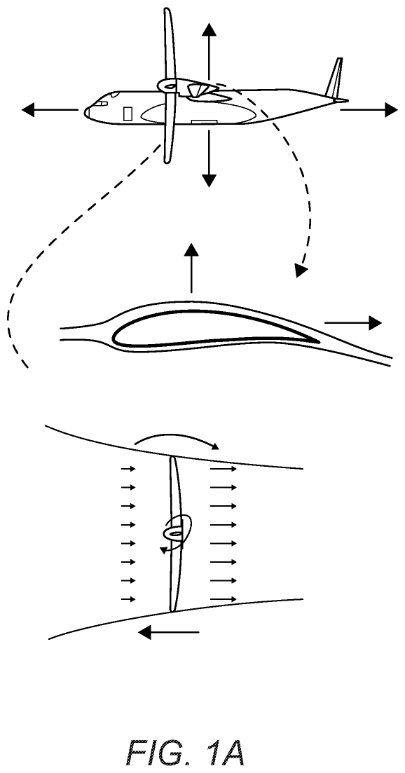

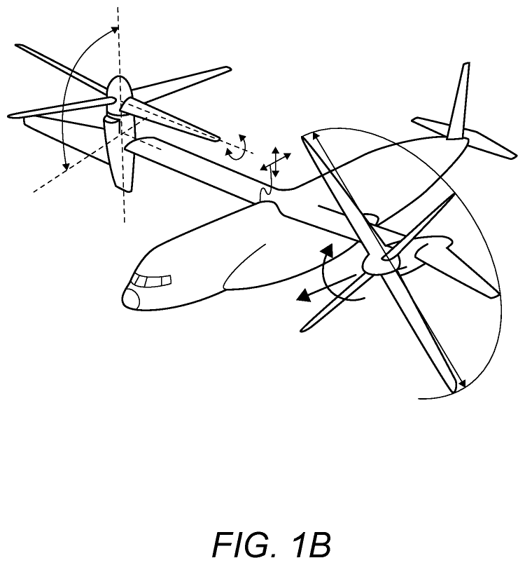

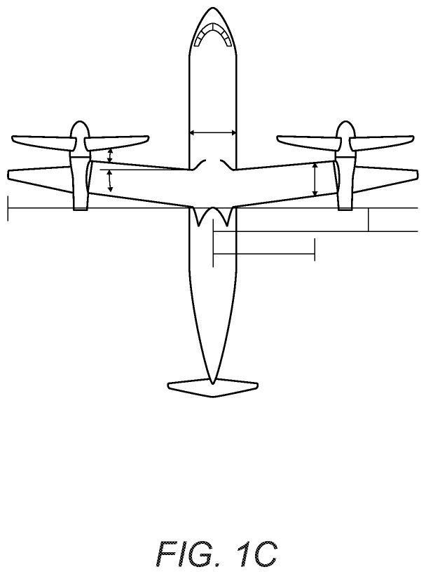

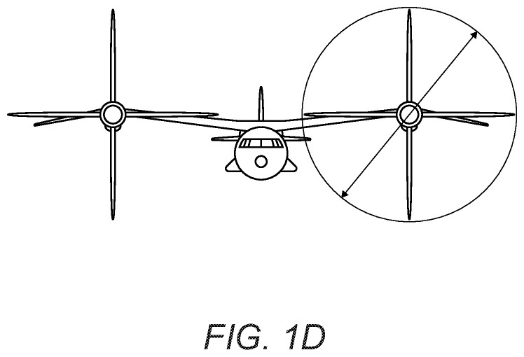

An example of a manned tilt rotor aircraft of the inventive concept is depicted FIGS. 1A to 1D. FIG. 1A shows a side views of an aircraft of the inventive concept, along with a cross section of a typical wing and propeller implementation. The top portion of FIG. 1A shows a side view of a manned aircraft of the inventive concept. As shown the aircraft has a forward crew compartment and a center of mass (indicated by a downward arrow) approximately centered and directly below a wing that provides lift (indicated by an upwards arrow). The aircraft is shown with the rotors positioned for horizontal flight, so thrust is in the forward direction and drag is directed towards the rear of the aircraft. It should be appreciated that the rotors of such an aircraft can be pivoted (for example, by rotating a nacelle upon which the propeller is mounted or by rotation of the wing or a portion thereof upon which the propeller is mounted) to provide varying amounts of vertical lift. A cross section of a typical wing with airflow corresponding to cruising flight is shown in the middle portion of FIG. 1A. As shown, in cruise or horizontal flight lift is provided by airflow over the wing contour. The bottom portion of FIG. 1A illustrates thrust provided by a rotor or rotating propeller of the aircraft, with rotation of the propeller or rotor generates a pressure differential providing forward thrust when in the aircraft is in cruise configuration. In aircraft of the inventive concept the payload or cargo bay is located at or near (e.g. within about 10% of the fuselage length) the aircraft's center of mass, and systems having significant weight (such as avionics, fuel stores, etc.) are arranged along the midline of the aircraft's fuselage. The cargo bay and the payload are dimensioned such that release of the payload from the aircraft (e.g. during flight and/or while not in flight) results in a minimal shift (e.g. equal to or less than about 4% of the fuselage length) in the position of the aircraft's center of gravity. Although not shown in this figure, in some embodiments the aircraft can include a quad landing gear with elements both fore and aft of the cargo bay (e.g. two struts fore and two struts aft) that can provide additional stability on release of payload, for example when the aircraft has landed.

FIG. 1B provides an oblique view of a manned aircraft of the inventive concept, with the port rotor in a cruise or horizontal flight condition and the starboard rotor in a vertical thrust position utilized for vertical flight. As shown a nacelle housing a motor to which the rotor is coupled and an outboard portion of the wing is rotated to achieve this, however in some embodiments only the nacelle housing the motor and its coupled propeller, only a propeller and an associated mounting structure, or the entire wing can be rotated in order to position the rotor for vertical thrust.

FIG. 1C shows a top-down view of a manned aircraft of the inventive concept, with the rotors in cruise position. FIG. 1D shows a front view of a manned aircraft of the inventive concept, with the rotors in cruise position. Although not shown in this figure, aircraft of the inventive concept can include an exhaust system outlet and/or infrared masking device that directs hot exhaust gases our from the upper surface of the aircraft in order to minimize infrared detection from the ground.

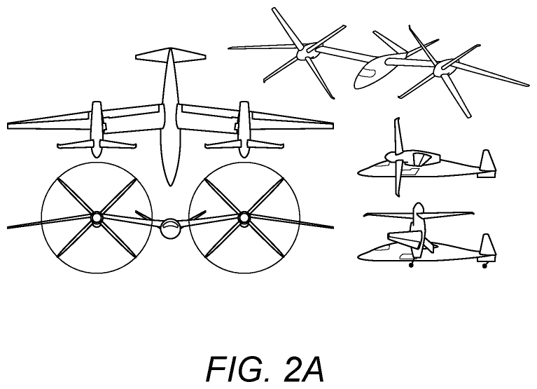

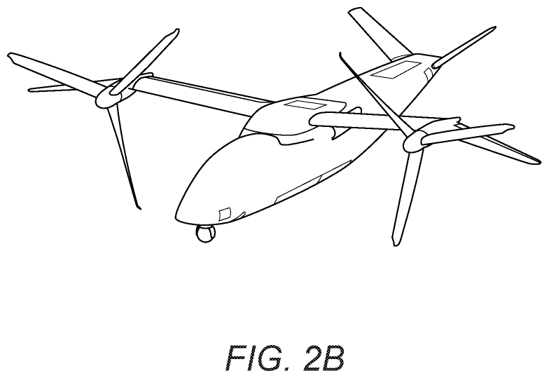

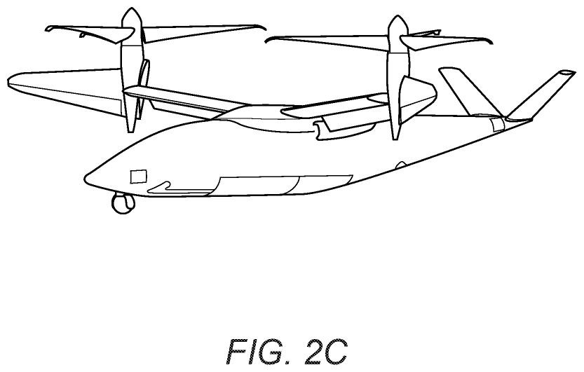

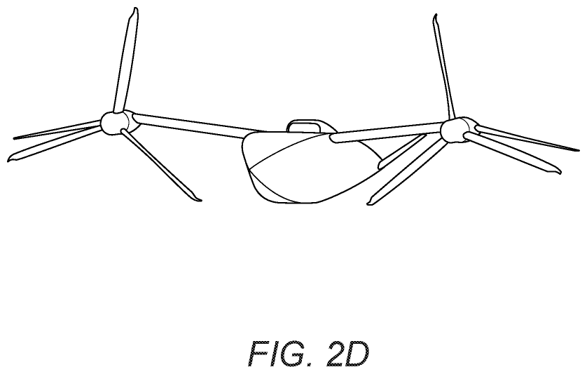

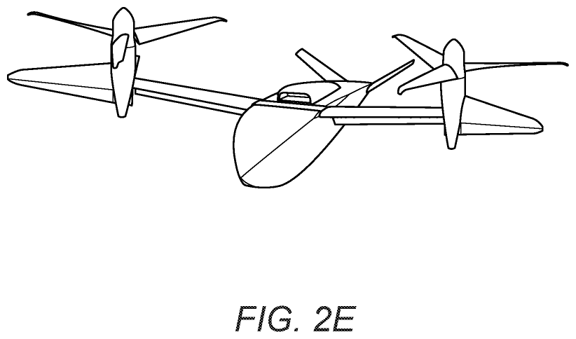

Examples of a two rotor unmanned tilt rotor aircraft of the inventive concept are shown in FIGS. 2A to 2E. FIG. 2A provides multiple views of such an aircraft. The top left panel shows a top-down view of an embodiment of an aircraft with slightly forward-swept wings. As shown in the oblique view on the top right and the front view on the lower left, the inner portions of the wings have a dihedral angle (e.g. from +1° to +15°) from their attachment points on the aircraft's fuselage and the outer portions of the wings have a negative dihedral/anhedral angle (e.g. from −1° to −15°). This arrangement further contributes to aircraft stability upon payload release while in flight. The lower right portion of the figure shows the aircraft configured for horizontal cruise and for vertical flight.

FIG. 2B provides a space filling oblique view of a two rotor unmanned tilt rotor aircraft of the inventive concept with rotors positioned for horizontal/cruise flight. FIG. 2C provides a similar view of the aircraft with rotors positioned for vertical flight and/or takeoff. FIGS. 2D and 2E provide space filling oblique views of a different embodiment of a two rotor unmanned tilt rotor aircraft of the inventive concept, with rotors positioned for horizontal/cruise flight (FIG. 2D) and for vertical flight/takeoff (FIG. 2E). In such unmanned aircraft an avionics package can be positioned forward of the cargo bay and along the midline of the aircraft. Such an avionics package can include a receiver and a transmitter that supports remote piloting, sensors and/or sensor inputs, and/or a processor that is coupled to control systems of the aircraft. Such a processor can include algorithms for partial of completely autonomous flight. In preferred embodiments such an aeronautics package is modular and removable. This can be accomplished by removal and replacement of an avionics module and/or by removal and replacement of a nose section that includes an avionics package. This advantageously permits rapid and simple reconfiguration of the aircraft for different environments and/or purposes, and simplifies repair.

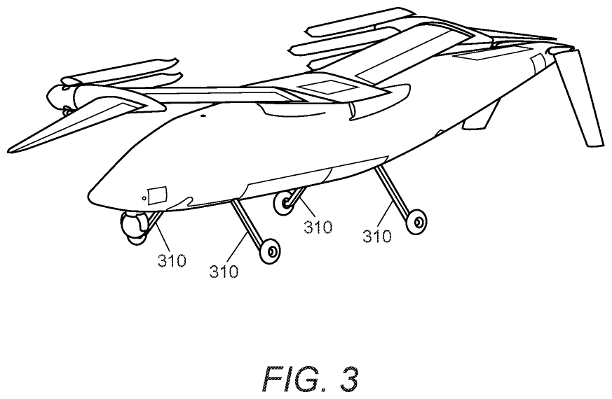

In some embodiments of the inventive concept the aircraft can be configured for compact storage, for example for transport or deployment on a vessel where space is limited. In such embodiments portions of the aircraft can be coupled the fuselage using rotating or swiveling connections, which permits extended portions (e.g. wings, tail sections) to be positioned to reduce the aircraft's storage volume. As shown in FIG. 3, in some embodiments portions of the wing and tail assemblies of the aircrafts can be pivoted and/or folded to reduce the external dimensions of the aircraft and simplify storage. The exemplary aircraft shown in FIG. 3 also shows an extended quad landing gear (310), which contributes to aircraft stability on storage, loading, fueling, and cargo delivery (when landed). This landing gear can fold for storage during flight.

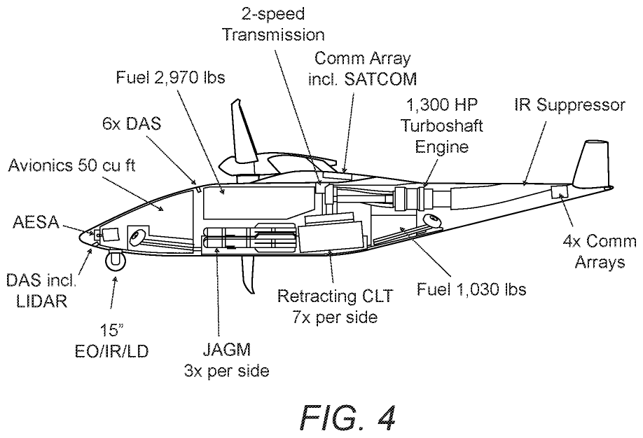

A cross section of an exemplary unmanned aircraft of the inventive concept is shown in FIG. 4. As shown dispensable high mass components such as fuel and payload can be arranged along the midline of the aircraft. In the example shown the payload includes a common launch tube (CLT) weapon system. The avionics package and the engine (which is fitted with a dorsally vented infrared suppressor) are also arranged along the midline. Fuel can be distributed in tanks positioned at least partially forward and behind the center of gravity, so that sequence-controlled fuel consumption during flight has minimal to no impact on the aircraft's center of gravity. Similarly, payloads to be delivered from the aircraft (e.g. during flight) can be positioned at or near the aircraft's center of gravity, such that when these are delivered from the aircraft there is minimal to no perturbation in the position of the aircraft's center of gravity (e.g. the CLT system of the exemplary aircraft). In this example weapons systems in the form of air-to-ground missile launchers are coupled to the sides of the aircraft at or near the center of mass, minimizing the shift in center of mass on deployment of the weapon.

The payload bay can be used to transport a variety of payloads that are released while the aircraft is in flight. Such payloads can include personnel, equipment, and supplies suitably provisioned for in-flight release and safe landing. In some embodiments the payload bay is positioned, dimensioned, or otherwise configured to store a weapon or weapon system. In a preferred embodiment the payload bay is configured to store and/or deploy two or more weapon systems or types. Suitable weapons types include rockets, missiles, bombs, air-to-air weaponry, and air-to-ground weaponry. Such weapons systems can include support, aiming, and/or launching subsystems (e.g. cradles, launch tubes, etc.). Payload bays can include one or more bay doors that are opened for release or deployment. Preferably, these are positioned beneath the aircraft. The payload bay can include a gravity drop mechanism used for releasing payload through such bay doors.

In some embodiments a vertical flight capable aircraft of the inventive concept can include weapons launchers that are mounted externally or in at a point that can be exposed. For example, a weapon launcher can be externally mounted, attached, or otherwise coupled to a side of the aircraft fuselage and/or an exterior door surface. Alternatively or in addition, a weapon launcher can be positioned and mounted to launch a weapon from a door of the vertical flight capable aircraft. Such weapon launchers can be mounted using a fixed mount, or can be reversibly coupled to the aircraft.

As noted above, aircraft of the inventive concept can be manned or unmanned. In manned embodiments a cockpit (which can include an avionics assembly) can be positioned forward of the cargo bay. In unmanned embodiments an avionics assembly can be positioned forward of the cargo bay. Such avionics assemblies are preferably modular and/or removable in order to simplify reconfiguration of the aircraft for a variety of mission profiles. In manned embodiments such an avionics assembly can include avionic, weather, and other sensor (e.g. radar, LIDAR, navigation) displays positioned to be observable by human pilots, as well as processors for autopilot and/or autonomous piloting functions. In unmanned embodiments such an avionics assembly can include a transmitter coupled to aircraft sensors that provide information to a remote pilot and a receiver for receiving instructions from a remote pilot, as well as a processor for implementing such instructions. In some embodiments an unmanned aircraft of the inventive concept includes a processor that permits partial and/or completely autonomous flight.

Vertical flight aircraft of the inventive concept can include features that reduce detectability. For example, such aircraft can be configured to provide a reduced or minimal radar cross section, utilize landing gear (e.g. a quad landing gear) that is retractable into the fuselage when not in use, constructed of minimally radar reflective composites, and/or incorporate radar-absorbing materials. Such aircraft can include features that reduce and/or minimize their observability in the visible and/or infrared spectrum. Such aircraft can, for example, incorporate camouflage coloration/pattern, infrared suppression on engine and/or exhaust systems, etc. In a preferred embodiment of the inventive concept aircraft of the inventive concept utilizing combustion engines incorporate an infrared suppressor, such as an upward directed exhaust positioned aft of the payload bay.

In some embodiments vertical flight aircraft of the inventive concept aircraft can be single engine aircraft. In such embodiment power from the single engine can be distributed to two or more rotors using a transmission or similar mechanism. Alternatively, other vertical flight aircraft of the inventive concept can include two or more engines. Suitable engines include electric motors, piston engines, turbojet engines, and/or jet engines. Aircraft with multiple engines can incorporate engines of different types. Single engine embodiments can include a single engine coupled to the fuselage or to the aircraft's wing, can have an output of up to about 1300 horsepower. Multi-engine embodiments of the aircraft can include two or more engines coupled to a wing and/or the fuselage of the vertical flight capable aircraft, where each of the engines has an output of about 700 to about 1300 horsepower.

In some embodiments of the inventive concept the aircraft can include various improvements to rotor, propulsion, and lift surface systems. For example, such an aircraft can utilize a Karem Aircraft OSR rotor (as described in U.S. Pat. No. 6,007,298, or a Karem Aircraft OSTR lift and propulsion system (as described in U.S. Pat. No. 6,641,365). Similarly, such aircraft can incorporate a Karem Aircraft Butterfly wing flap (as described in US provisional patent application No. 15/985507) in order to reduce download and increase lift during transition flight. Exemplary characteristics of unmanned single and dual engine aircraft of the inventive concept are shown below.

| Small Single Engine | | Big Single Engine | |
|---|---|---|---|
| Dimensions | | Dimensions | |
| Rotor diameter | 16 Ft | Rotor diameter | 25 Ft |
| Wing Span | 40 Ft | Wing Span | 62 Ft |
| Fuselage Length | 33 Ft | Fuselage Length | 48 Ft |
| Weights | | Weights | |
| SDGW 4,950 Lb | | SDGW 13,800 Lb | |
| Propulsion | | Propulsion | |
| Two 3-Blade OSTR Rotors | | Two 3-Blade OSTR Rotors | |
| Single 1,300 HP Turboshaft Engine | | Single 3,060 HP Turboshaft Engine | |
| 2-Speed Transmission | | 2-SpeedTransmission | |
| Small Dual Engine | | Big Dual Engine | |
| Dimensions | | Dimensions | |
| Rotor diameter | 16 Ft | Rotor diameter | 25 Ft |
| Wing Span | 40 Ft | Wing Span | 62 Ft |
| Fuselage Length | 33 Ft | Fuselage Length | 48 Ft |
| Weights | | Weights | |
| SDGW 4,950 lbs | | SDGW 12,350 lbs | |
| Propulsion | | Propulsion | |
| Two 3-Blade OSTR Rotors | | Two 3-Blade OSTR Rotors | |
| Two 700 HP Turboshaft Engines | | Two 1,300 HP Turboshaft Engines | |
| 2-Speed Transmission | | 2-SpeedTransmission | |

Vertical flight capable aircraft may need to be deployed under suboptimal weather conditions in order to meet mission needs. Accordingly, aircraft of the inventive concept can include safety features that provide it with the ability to fly in all weather conditions. Such an aircraft can include an electro-thermally heated portion of aircraft skin, which can be used for deicing. Such electro-thermally heated portions can be flight surfaces (e.g. wings, flaps, etc.) that are prone to developing ice under harsh conditions. Such an aircraft can include a lighting-strike protection feature in order to reduce or minimize the impact of lightning strikes on or near the aircraft. Such an aircraft can include an engine air particle separator to reduce or minimize the impact of airborne particulates (e.g. sand, dust, ash) on air-breathing engines. Similarly, such an aircraft can include abrasion-resistant surfaces and/or surface coatings to protect vulnerable surfaces (e.g. propellers, leading wing and control surface edges, windows) from such airborne particulates. In some embodiments of the inventive concept the vertical flight capable aircraft can include a sensor suite that provides pilots and/or autonomous piloting systems with safety-related data. Such sensors can include radar, wind speed, temperature, humidity, air pressure, particle size, particle count, a multi-functional RF array, a multi-spectral EO/IR/LD ball, a distributed aperture system, and/or a LIDAR receiver and processor) which can, separately and/or in combination, facilitate operation of such an aircraft in all-weather conditions.

In some embodiments vertical flight capable aircraft can include features that reduce the need for regular maintenance and/or provide extended (e.g. one month or more) periods of maintenance-free operation. This is particularly useful for autonomous or remotely piloted aircraft on long duration flights. Such features can include an all-electric architecture, which can incorporate the use of electric motors and storage systems for electric power (e.g. batteries, supercapacitors, fuel cells and associated fuel, etc.). In such embodiments the aircraft can include one or more photovoltaic panels). Alternatively, if a combustion engine is utilized the aircraft can incorporate a low-maintenance engine air particle separator. It should also be appreciated that incorporation of abrasion resistant surfaces and/or surface coatings at high wear points can increase the interval between necessary maintenance. The interval between maintenance stops can also be increased by reducing vibration resulting from operation of the aircraft (e.g. through the use of higher-harmonic blade pitch control system, a rigid rotor system, and/or a vibration mitigation system). Use of multiple (e.g. two or more) modular payload systems can also increase the period between necessary maintenance by reducing wear on the payload system. In preferred embodiments of the inventive concept the interval between necessary maintenance on a vertical flight capable aircraft of the inventive concept can be extended to two weeks, a month, six weeks, two months, three months, four months, six months, eight months, ten months, 1 year, eighteen months, two years, or more.

As noted above, the payload bay of a vertical flight capable aircraft of the inventive concept can include payload bay doors that are positioned beneath the aircraft. Such a payload bay can include a delivery mechanism that extends the payload (or a portion of the payload) below and exterior to the aircraft. Such a mechanism can provide for fore delivery, aft delivery, or both fore and aft delivery. The aircraft can also include one or more bay door(s) positioned to provide access to the payload bay. In preferred embodiments such a mechanism is released on opening the bay door(s) in response to gravity. In some embodiments, payload bay doors of the inventive concept may not be structurally capable of supporting heavy payloads, in order to reduce aircraft weight when heavy payload transport is not required. In such embodiments payload bay doors can be optionally reinforced with additional reinforcing structure(s) to allow heavy payloads to be carried and/or delivered from payload bay doors. In embodiments of the inventive concept, a payload bay (for example, a weapons bay) can be centered or distributed close to (e.g. within 10% of the aircraft fuselage length) or at the aircraft's center of gravity. Similarly, release of some or all of the contents of the payload bay can result in minimal (e.g. less 10%, less than 5%, or about 1% or less) or no shift in the position of the aircraft's center of gravity relative to the length of the aircraft's fuselage.

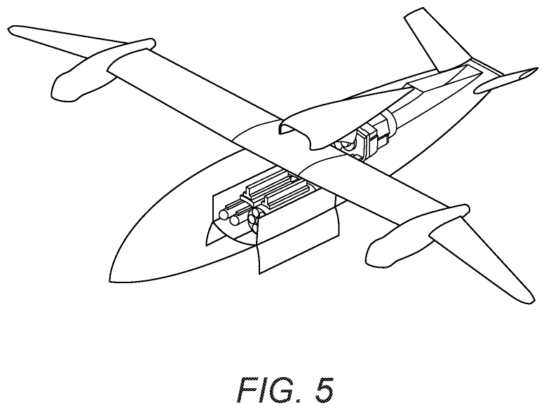

An examples of an unmanned aircraft of the inventive concept that includes payload bay configured as a weapons bay is shown in FIG. 5, which shows a partial interior view of an aircraft of the inventive concept carrying two different weapons systems positioned side-by-side in a cargo bay (note that rotor blades are not depicted). The bay doors have been opened, allowing the weapons systems to drop into release position below the aircraft. In preferred embodiments this is accomplished using gravity.

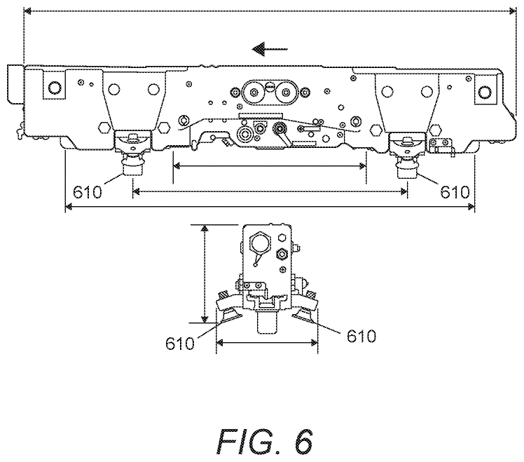

Such a payload bay can include accessory systems for release or delivery of payload from the aircraft. For example, a payload bay of an aircraft of the inventive concept can include an ejection rack dimensioned to fit within the payload bay, as shown in FIG. 6. The top portion of the figure shows a side view of an exemplary ejection rack, which includes attachment points (610) for payload items. The lower portion of the figure shown an end-on view of the ejection rack. In preferred embodiments such an ejection rack is triggered by either its own weight or that weight in combination with that of the payload when the bay doors are opened.

As noted above, aircraft of the inventive concept can carry a wide variety of payloads. In some embodiments a vertical flight capable aircraft of the inventive concept includes a missile launch system. Such a missile launch system positioned completely or partially within the payload bay of the vertical flight capable aircraft. Such a missile launch system can be designed to hold and launch a single missile or two or more missiles. In such embodiments the payload bay can incorporate or contain launch system suitable for the delivery or launching of weaponry from the payload bay, either while the aircraft is in flight or on the ground. In preferred embodiments such a missile launcher can hold for transport and launch at least two missiles. Suitable missile launch systems include rail systems, which provide adequate support for safe transport of missiles during aircraft operations and also provide support and initial guidance during launch. Such a rail system can be stored entirely within the payload bay or partially stored within the payload bay (e.g. with a portion of the rail system exposed during flight). Such rail systems are preferably extended from the aircraft using gravity upon release of a retaining mechanism (e.g. by opening bay doors. Examples of suitable missile launch systems include a JAGM rail system, a LAU-61 system, and/or a LAU-131 system.

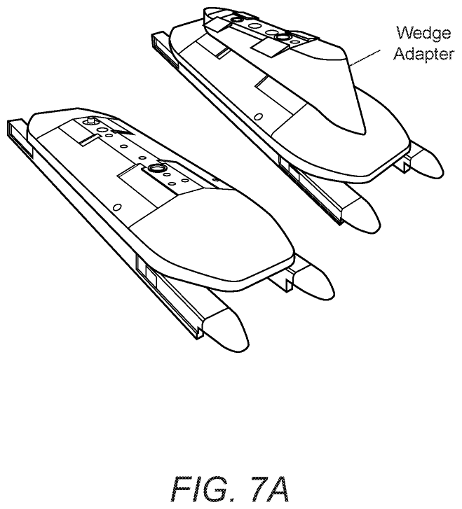

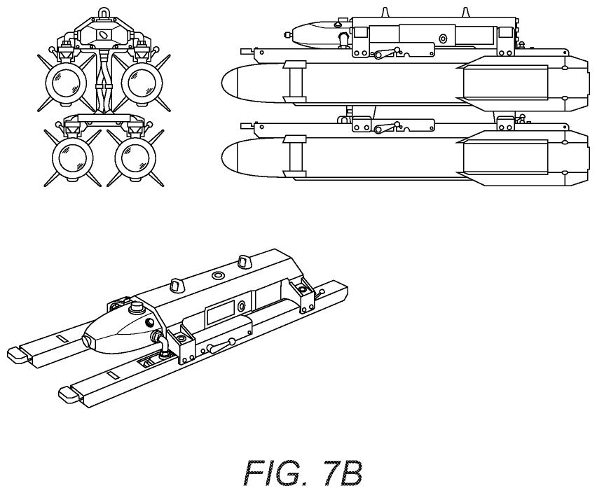

Examples of a suitable multi-rail system is shown in FIGS. 7A and 7B. FIG. 7A shows an exemplary dual rail launcher that is configured to fit within a cargo bay of an aircraft of the inventive concept. The example shown can include a wedge adapter, which provides a defined launch angle relative to the aircraft upon deployment. FIG. 7B shows a different embodiment of a multiple rail launcher. The top portion of the figure shows fore-aft (left) and side (right) views of a four rail launch system with missiles in place. The bottom portion of the figure shows a similar launcher configured to carry and launch two missiles.

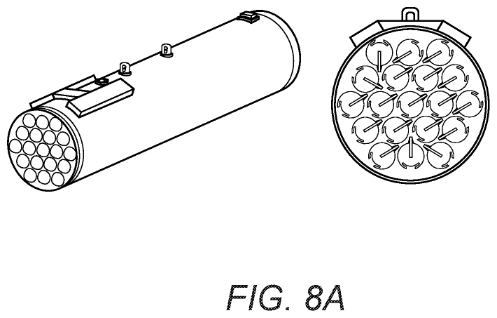

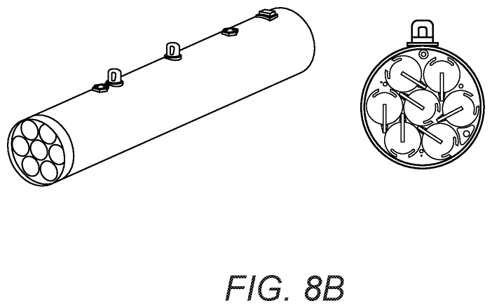

Other examples of suitable weapons launching systems utilize a cluster of open ended tubes, which can be used for storage and deployment of weapons or other equipment (e.g. drones) from an aircraft of the inventive concept. Examples include the LAU-61 and LAU-131 rocket launchers, shown in FIGS. 8A and 8B, respectively.

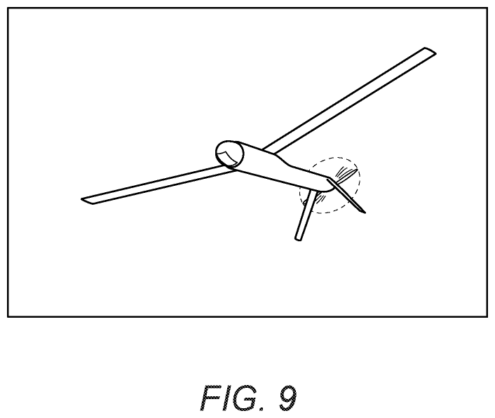

Similarly, in some embodiments a vertical flight capable aircraft of the inventive concept can include an unmanned aerial vehicle (UAV) release system, at least a portion of which can be positioned within the payload bay. Such an UAV launch system can store and release a single UAV, or can be designed to store and release two or more UAVs. In preferred embodiments such a UAV launch system can hold for transport and launch at least two UAVs, which can be identical or different. Suitable UAV launch systems include tube systems, which provide one or more tubes that provide adequate support for safe transport of UAVs (for example, in a folded configuration) during aircraft operations and also provide support and initial guidance during launch. Such a tube system can be stored entirely within the payload bay or partially stored within the payload bay (e.g. with a portion of the tube system exposed during flight). Such tube systems are preferably extended from the aircraft using gravity upon release of a retaining mechanism (e.g. by opening bay doors. Such UAVs can be piloted remotely, semi-autonomous, or autonomous. For example, an aircraft of the inventive concept can launch one or more UAVs, such as the Altius UAV shown in FIG. 9, using a common launch tube (CLT) system.

Such UAVs can weigh up to about 45 pounds and can have an in-air endurance of up to 4.5 hours. Common launch tubes configured to store and release such UAVs can be held within a payload bay of the aircraft, or mounted externally. Typically, a CLT can have a diameter of about 6 inches and a length of about 48 inches, and can be closely packed to reduce space requirements. For example, a group of 7 CLT can be packed and arranged so as to provide a CLT assembly having dimensions similar to that of the LAU-61 system described above.

Stability of aircraft of the inventive concept when not in flight can also be improved by positioning of wheels or similar landing gear so as to improve aircraft stability on the ground when loading heavy payloads and/or refueling. For example, as shown in FIG. 3, a quad landing gear (310) can be extended in pairs positioned both forward and behind the aircraft's center of gravity. Such a landing gear can be dimensioned to provide adequate fuselage to ground clearance and/or access for loading of bulky and/or heavy payloads (e.g. weapons). In some embodiments such wheels or similar devices can be extended beyond the sides of the fuselage on legs in order to provide additional stability. In such embodiments the legs of such a landing gear can be made of composite materials, and can be designed to absorb the landing energy without the use of a traditional oleo shock absorber. In some embodiments such legs can be repositioned for storage within the fuselage during flight.

In some embodiments, portions of the aircraft of the inventive concept can be removable and/or modular. For example, an avionics module and/or nose of the aircraft (which can incorporate all or part of an avionics module) can be removable/replaceable. This advantageously permits the aircraft to have mission systems modules are interchangeable, providing for facile reconfiguration of the aircraft.

In some embodiments, an aircraft of the inventive concept can include features that improve system durability, reduce the need for regular maintenance, and/or increase the intervals between maintenance. Aircraft of the inventive concept can include features reduce the need for engine maintenance, such as an all-electric architecture (e.g. use of electric motors) or a low-maintenance engine air particle separator (such as an inlet particle separator). Wear and tear can also be reduced by reducing the number of moving parts and/or reducing vibration, for example by using higher-harmonic blade pitch control, a vibration mitigation system, and/or a rigid rotor system. Portions of the aircraft that are subject to wear or abrasion can incorporate abrasion resistant materials and/or coatings. Finally aircraft of the inventive concept can be of modular construction, which greatly simplifies maintenance and reconfiguration while also reducing the level of technical skill and training required to do so. Such features can, in combination, contribute to long maintenance-free periods of operation (e.g. greater than 1 month, greater than 3 months, greater than 6 months, and/or greater than 1 year) and can improve the maintainability of the aircraft compared with those of the prior art.

Aircraft of the inventive concept can include components that permit them to operate in a wide range of environmental conditions. For example, an aircraft of the inventive concept can include a de-icing feature, such as an electro-thermally heating for at least a portion of the aircraft's skin, to permit operation in cold weather and/or high altitude. Similarly, aircraft of the inventive concept can include a lighting-strike protection feature, to permit operation in inclement weather. For under dusty or sandy conditions an aircraft of the inventive concept can include an engine air particle separator, as well as surfaces (e.g. nose, leading wing and tail surfaces, etc.) that incorporate abrasion-resistant materials and/or coatings. Finally, aircraft of the inventive concept can include a sensor suite to identify and avoid potential hazards.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A vertical flight capable aircraft comprising:
a fuselage having a fuselage length; and
a payload bay positioned within about 10% of the fuselage length of the vertical flight capable aircraft's center of gravity,
wherein deployment of a payload from the payload bay results in a shift in position of the vertical flight capable aircraft's center of gravity of less than 4% of the fuselage length.

2. The vertical flight capable aircraft of claim 1, wherein the payload bay is configured to store a plurality of weapon types.

3. The vertical flight capable aircraft of claim 1, further comprising a quad landing gear, wherein the quad landing gear is retractable into the fuselage.

4. The vertical flight capable aircraft of claim 1, wherein the payload bay comprises bay doors positioned beneath the vertical flight capable aircraft, and further comprises a gravity drop mechanism for release of payload through the bay doors.

5. The vertical flight capable aircraft of claim 1, further comprising a weapon launcher coupled to a side of the fuselage.

6. The vertical flight capable aircraft of claim 1, further comprising a weapon launcher configured to launch a weapon from a door of the vertical flight capable aircraft.

7. The vertical flight capable aircraft of claim 1, further comprising an avionics assembly positioned forward of the payload bay.

8. The vertical flight capable aircraft of claim 7, where the avionics assembly is modular or removable.

9. The vertical flight capable aircraft of claim 1, further comprising an infrared suppressor positioned aft of the payload bay.

10. The vertical flight capable aircraft of claim 1, further comprising a single engine coupled to the fuselage.

11. The vertical flight capable aircraft of claim 1, further comprising two or more engines coupled to a wing of the vertical flight capable aircraft.

12. The vertical flight capable of claim 1, wherein the vertical flight capable aircraft is unmanned.

13. The vertical flight capable of claim 1, wherein the vertical flight capable aircraft comprises one or more of an electro-thermally heated portion of aircraft skin, a lighting-strike protection feature, an engine air particle separator, an abrasion-resistant surface coating, and a sensor suite, and is capable of flight in all-weather conditions.

14. The vertical flight capable of claim 1, wherein the vertical flight capable aircraft comprises one or more of an all-electric architecture, a higher-harmonic blade pitch control system, a vibration mitigation system, a rigid rotor system, a plurality of modular mission systems, a low-maintenance engine air particle separator, and an abrasion-resistant surface coating, and is capable of long periods of maintenance free operation.

15. The vertical flight capable aircraft of claim 1, wherein the payload bay comprises payload bay doors positioned beneath the vertical flight capable aircraft, and further comprises a delivery mechanism configured to extend payload below and exterior to the vertical flight capable aircraft for delivery fore or aft of the aircraft.

16. The vertical flight capable aircraft of claim 1, further comprising a payload bay door positioned to provide access to the payload bay, and further comprising a removable reinforcing structure coupled to at least a portion of the payload bay door.

17. The vertical flight capable aircraft of claim 1, further comprising a missile launch system at least partially positioned within the payload bay.

18. The vertical flight capable aircraft of claim 1, further comprising a payload release system.

19. The vertical flight capable aircraft of claim 1, further comprising a UAV release system positioned within the payload bay.

20. The vertical flight capable aircraft of claim 19, wherein the UAV release system comprises a common launch tube.
